(19) United States
(12) Patent Application Publication
(10) Pub. No.: US 2026/0349390 A1
(43) Pub. Date: Nov. 5, 2026

(54) METHOD FOR ADJUSTING A TIMEPIECE MOVEMENT WITH THE AIM OF PROMOTING AND/OR BALANCING THE RESTARTING THEREOF

(71) Applicant: ROLEX SA, Geneva (CH)

(72) Inventors: Raphaël Cettour-Baron, Thonon-les-Bains (FR); Cédric Hentsch, Cologny (CH)

(73) Assignee: ROLEX SA, Geneva (CH)

(21) Appl. No.: 19/476,302

(22) PCT Filed: Apr. 17, 2024
(86) PCT No.: PCT/EP2024/060448

§ 371 Date: Nov. 26, 2025

(30) Foreign Application Priority Data
Apr. 17, 2023 (EP) 23168332.7

(51) Int. Cl. G04B 18/08; G04B 18/04

(52) U.S. Cl. CPC G04B 18/08; G04B 18/04

(57) ABSTRACT

The method is for adjusting a regulating system (100) including an oscillator (2) having an inertial element (21) pivoted around a pivot axis and a return spring (22), notably a balance-wheel (21)/mainspring (22) oscillator, and an escapement (3), notably a dual impulse escapement, particularly a Swiss lever anchor escapement (3). The adjustment method includes, in order to facilitating and/or balancing the restarting of the regulating system: adjusting the beat setting, notably to a non-zero value, and/or adjusting the degree of entry penetration of a pallet assembly (31) into an escape wheel (32), and/or adjusting the degree of exit penetration of the pallet assembly into the escape wheel.

The invention relates to a method for adjusting a regulating system in order to facilitating and/or balancing the restarting thereof. The invention also relates to a regulating system obtained by implementing such an adjustment method. The invention further relates to a timepiece movement obtained by implementing such an adjustment method. The invention finally relates to a timepiece comprising such a timepiece movement or such a regulating system.

There is nothing straightforward about restarting a timepiece movement when it has stopped because the mainspring is unwound or under the action of a stop-second during a time-resetting operation. Specifically, it is necessary on the one hand for a sufficiently high torque to be applied by the escape wheel to the pallet assembly, and also for the escapement to be in a configuration that allows the pallet assembly to apply to the oscillator an impulse that will enable it to resume oscillation. In practice, a slight movement applied to the watch, which causes the oscillator balance to rotate, is often needed in order for the oscillator to begin oscillating again and therefore for the timepiece movement to restart. In addition, it would appear that certain types of escapement restart more readily than others.

Restarting has hitherto been given very little consideration in the world of horology, but is important to the wearer of the watch. Specifically, said wearer wishes to rewind their timepiece as little as possible in order to cause it to restart, and also wishes to avoid the need to apply an acceleration to their timepiece in order to facilitate the restart.

Document CH716421A2 proposes a system for facilitating restarting particularly in the case of a tourbillon timepiece. A stop cam is provided to stop the balance in a clearly defined angular position different than the neutral point of the oscillator, so as to facilitate the restarting of the oscillator.

Document CH716525A1 provides a restart system for an oscillator with a flexible blade pivoting. A mechanical impulse wheel, powered by an energy source, is activated when the amplitude of oscillation of the oscillator is zero or below a given value, in order to impart energy to the oscillator.

Document CH717217A2 describes a mechanism for the “gentle” restart of a balance-wheel/mainspring oscillator by using an additional mechanism to apply movement to the balance.

The object of the invention is to provide an adjustment method that improves restarting of a timepiece movement that has stopped and that improves the timepiece movements known from the prior art. In particular, the invention proposes an adjustment method that facilitates the restarting of a timepiece movement that has stopped.

According to a first aspect of the invention, an adjustment method is defined by claim 1.

Embodiments of a determining method are defined by claims 2 to 8.

According to a first aspect of the invention, a regulating system is defined by claim 9.

According to a first aspect of the invention, a timepiece movement is defined by claim 10.

According to a first aspect of the invention, a timepiece is defined by claim 11.

According to another aspect of the invention, notably according to an aspect complementary to the invention, subjects are defined by the following propositions.
1. A method for determining, notably by calculation, a beat setting value for an oscillator (2), notably an oscillator comprising an inertial element (21) pivoted around a pivot axis and a return spring (22), notably a balance-wheel (21)/mainspring (22) oscillator, in a timepiece movement (200), the method comprising at least the following steps:
   Setting the oscillator in oscillatory motion relative to a frame (99) of the timepiece movement,
   Positioning the timepiece movement in at least two determined positions with respect to the direction of the Earth's gravitational field,
   For each position, determining data relating to the beat setting of the oscillator (2),
   Using the data from the preceding step to determine a beat setting value of the oscillator (2), notably a directional value of the beat setting and/or function defining the directional value of the beat setting according to the position of the timepiece movement with respect to the direction of the Earth's gravitational field.
2. The method as proposed in proposition 1, wherein the beat setting value is a temporal value.
3. The method as proposed in one of the preceding propositions, wherein the oscillator comprises an axis of oscillation that makes an angle of at least 2° or of at least 3° with the direction of the Earth's gravitational field:
   in one of the positions of the step of positioning the timepiece movement, or
   in some of the positions of the step of positioning the timepiece movement, or
   in all of the positions of the step of positioning the timepiece movement.
4. The method as proposed in one of the preceding propositions, wherein at least one of the determined positions is such that the angle between:
   the orthogonal projection of the line of centers (L) onto a plane (P) of the timepiece movement, and
   an orthogonal projection of the direction of the Earth's gravitational field onto the plane (P) of the timepiece movement,
is zero or has an absolute value less than 5° or has an absolute value less than 10°,
and/or wherein at least one of the determined positions is such that the angle between:
   the orthogonal projection of the line of centers (L) onto the plane (P) of the timepiece movement, and
   an orthogonal projection of the direction of the Earth's gravitational field onto the plane (P) of the timepiece movement,
is equal to 90° or has an absolute value comprised between 85° and 95° or has an absolute value comprised between 80° and 100°.
5. The method as proposed in one of the preceding propositions, wherein at least two determined positions are vertical positions of the timepiece movement and/or are positions which are approximately 90° apart about an axis perpendicular to the frame.
6. The method as proposed in one of the preceding propositions, wherein the function defining the directional value of the beat setting according to the position of the timepiece movement is defined as a sinusoidal function or as a polynomial function or as a Bezier function or as a spline function best corresponding to the data relating to the beat setting of the oscillator.
7. The method as proposed in one of the preceding propositions, wherein it comprises a step of determining an amplitude of oscillation of the oscillator (3).
8. The method as proposed in the preceding proposition, wherein it comprises a step of using the amplitude of oscillation of the oscillator (2) to determine an angular value of the beat setting.
9. The method as proposed in one of the preceding propositions, wherein the determinations of the data relating to the beat setting of the oscillator (2) and/or of amplitudes of oscillation of the oscillator (2) are performed by processing acoustic signals or by processing acoustic and optical signals.
10. A method for adjusting an oscillator (2), wherein it comprises a phase of implementing the method as proposed in one of the preceding propositions and a phase of adjusting the value of the beat setting of the oscillator (2).
11. A method for adjusting an oscillator (2), wherein it comprises a phase of positioning the timepiece movement in a predetermined position and a phase of adjusting the value of the beat setting to a zero value or to a non-zero value in this predetermined position
12. The adjusting method as proposed in proposition 10 or 11, wherein the phase of adjusting the value of the beat setting involves moving a hairspring attachment support relative to a frame (99).

According to another aspect of the invention, objects thereof are defined by the following proposals:
13. A method for adjusting a regulating system (100) comprising:
   an oscillator (2), notably a balance-wheel (21)/mainspring (22) oscillator, and
   an escapement (3), notably a dual impulse escapement, particularly a Swiss lever anchor escapement (3),
the adjustment method comprising, in order to facilitating and/or balancing the restarting of the regulating system:
   a step of adjusting the beat setting, notably to a non-zero value, and/or
   a step of adjusting the degree of entry penetration of a pallet assembly (31) into an escape wheel (32), and/or
   a step of adjusting the degree of exit penetration of the pallet assembly into the escape wheel.
14. The adjustment method according to proposal 13, wherein the step of adjusting the beat setting comprises a sub-step of positioning the regulating system (100) at a given orientation relative to the Earth's gravitational field.
15. The adjustment method according to proposal 14, wherein the step of adjusting the beat setting comprises a sub-step of adjusting the beat setting to a value, notably the zero value, while the regulating system (100) is positioned at the given orientation relative to the Earth's gravitational field.
16. The adjustment method according to one of proposals 13 to 15, wherein the non-zero value to which the beat setting is set is comprised between −3° and +3°, more specifically between −3° and −0.1° and between +0.1° and +3°, and the change to the beat setting is comprised between −3° and +3°, more specifically between −3° and −0.1° and between +0.1° and +3°.
17. The adjustment method according to one of proposals 13 to 16, wherein the step of adjusting the entry penetration of the pallet assembly into the escape wheel comprises:
   a sub-step of measuring the entry penetration, then
   a sub-step of controlled movement of an entry pallet relative to the rest of the pallet assembly, for example a controlled movement of the entry pallet by less than 20 μm relative to the rest of the pallet assembly, then
   a sub-step of securing the entry pallet to the rest of the pallet assembly.
18. The adjustment method according to one of proposals 13 to 17, wherein the step of adjusting the exit penetration of the pallet assembly into the escape wheel comprises:
   a sub-step of measuring the exit penetration, then
   a sub-step of controlled movement of an exit pallet relative to the rest of the pallet assembly, for example a controlled movement of the exit pallet by less than 20 μm relative to the rest of the pallet assembly, then
   a sub-step of securing the exit pallet to the rest of the pallet assembly.
19. The adjustment method according to one of proposals 13 to 18, wherein the adjustment method comprises, prior to the adjustment step, a step of defining the adjustment to be performed, this step of defining the adjustment comprising:
   a sub-step of measuring or determining or estimating the entry restart torque and of measuring or determining or estimating the exit restart torque or a sub-step of measuring or determining or estimating the difference in restart torque between the entry and the exit, and
   a sub-step of using the torque measurements or determinations or estimates to determine, notably through calculation, the nature and the intensity of the adjustment to be applied to the regulating system (100).
20. The adjustment method according to proposal 19, wherein the sub-step of using the torque measurements or determinations or estimates involves exploitation of the following formula:

Mred=M0+ap×p+ar×r

where
Mred is the difference in restart torque (between the entry restart torque and the exit restart torque),
p is the difference in penetration between the entry penetration and the exit penetration,
r is the beat setting,
M0, ap and ar are constants.
21. A regulating system (100) obtained by implementing the adjustment method according to one of proposals 13 to 20.
22. A timepiece movement (200) comprising an adjustment system (100) according to proposal 21.
23. A timepiece (300), notably a wristwatch, comprising a timepiece movement (200) according to proposal 22 and/or a regulating system (100) according to proposal 21.

The attached drawings depict, by way of example, mechanisms in which the methods according to the invention are implemented, and illustrate phenomena on which the methods according to the invention are based.

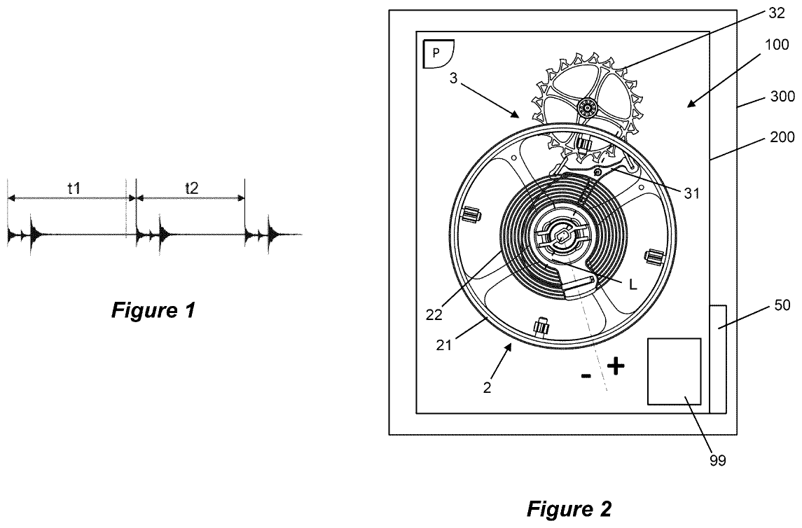

FIG. 1 is a time graph illustrating the vibrations detected at the escapement of a timepiece during a period of oscillation of a balance of a timepiece.

FIG. 2 is a schematic view of a timepiece, viewed by way of example from the back side, to which the methods that form the subjects of the invention may be applied.

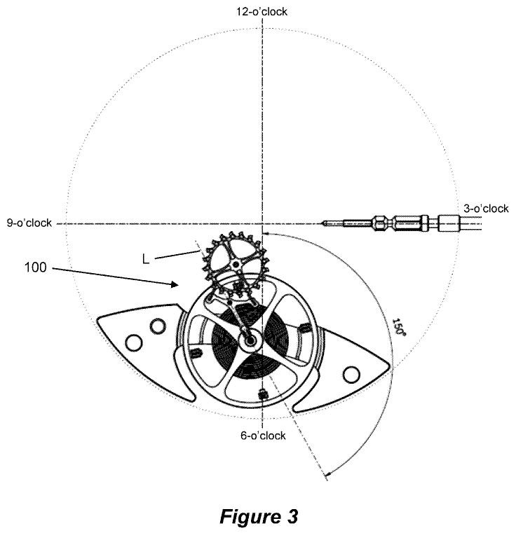

FIG. 3 is a view of a design of a timepiece movement, viewed by way of example from the dial side, detailing the orientation of a regulating system.

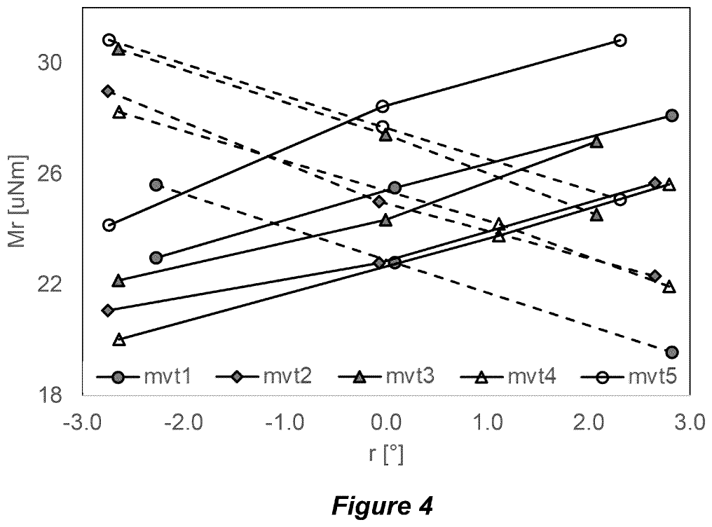

FIG. 4 is a graph showing the variations in entry and exit restart torques for five timepiece movements having different penetration values, the restart torque variations being indicated as a function of the adjustment to the beat setting.

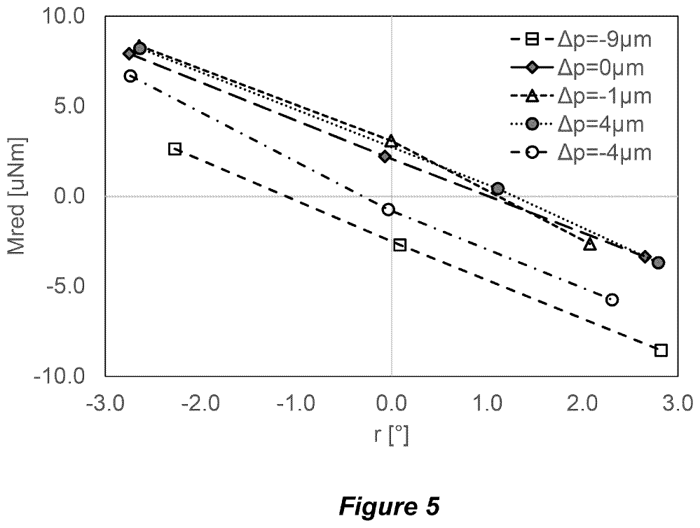

FIG. 5 is a graph showing the variations in entry and exit restart torque differentials for five timepiece movements having different penetration differential values, the variations in restart torque differentials being indicated as a function of the adjustment to the beat setting.

One embodiment of a timepiece 300 is described in detail below with reference to FIG. 2. The timepiece 300 is for example a watch, in particular a wristwatch. The timepiece 300 comprises a timepiece movement 200 to which a dial 50 is advantageously fixed. The timepiece movement is intended to be mounted in a timepiece casing or case in order to protect it from the external environment. The timepiece movement 200 may be a mechanical timepiece movement, notably an automatic timepiece movement, or a hybrid timepiece movement.

The timepiece movement 200 comprises a frame 99 and a regulating system 100.

The regulating system 100 comprises an oscillator 2 and an escapement system, such as a Swiss lever anchor escapement 3.

The oscillator 2 comprises:
an inertial element 21, such as a balance 21, and
a return spring 22, such as a hairspring 22.

The escapement comprises an escape wheel 32 and a pallet assembly 31, the pallet assembly interacting:
on the one hand, with the oscillator 2, and
on the other hand, with the escape wheel 32.

The line connecting the pivot points of the balance hairspring and of the pallet assembly, in other words, the line that connects:
the pivot axis of the inertial element, particularly of the balance-spring, and
the pivot axis of the pallet assembly, (in a plane perpendicular to these axes), is usually called the line of centers L.

### Principles and Work on the Concept of Beat Setting

Although watchmakers measure the beat setting as an interval of time, FIG. 2 shows that the beat setting is defined by the angular offset between the neutral points of the escapement and of the oscillator. For historical reasons, this quantity is expressed in milliseconds [ms] and thus characterizes half the time difference between two successive alternations (the term being equivalent to half-oscillations). In practice, this differential time is dependent on the speed of passage of the oscillator and therefore dependent on the amplitude and frequency thereof.

Work conducted by the applicant has revealed that the measured value of the beat setting is dependent on the amplitude of the timepiece movement and on its position at the time of measurement. These observations have led to a redefinition of the beat setting (concepts of signed beat setting and of geometric beat setting), to the development of procedures for measuring the sign and the value of the beat setting, and to the development of applied methods that exploit these concepts.

Historically, the beat setting has always been a zero or positive quantity expressed in [ms], which corresponds to the absolute time offset between the position of equilibrium of the oscillator (defined by the direction passing through the center of the impulse pin of the balance at rest and the axis of pivoting of the balance) and the line of centers of the pivoting of the balance and of the pallet assembly, with a target of setting this to zero.

Following the work conducted by the applicant, it ultimately appears advantageous:
to consider the beat setting as being a value that can be negative, zero or positive (signed or directional beat setting);
to measure the beat setting as an angle, in [°] or [rad] for example (geometric beat setting);
to measure the beat setting, experimentally, in a number of vertical positions in order to determine therefrom the sign and to deduce therefrom the beat setting at the midpoint (which is to say the mean of the beat settings in four vertical positions spaced 90° apart);
to orient the timepiece movement very precisely when setting the beat setting (or adjusting the beat setting) so that the beat setting set in this orientation corresponds with the beat setting at the midpoint.

From a physical standpoint, the beat setting is a quantity centered on zero, the sign of which is dependent on the direction of the angular offset. The beat setting as currently measured is not signed. Apart from the fact that this quantity therefore does not follow a normal distribution, there is a risk of arriving at false conclusions regarding a difference or a drift in the value of the beat setting between two states, notably between two measurements of the same timepiece movement at two different moments in time, such as before and after an adjustment operation or a shock test or an exposure to a magnetic field. For example, a conclusion of zero drift may be reached, whereas in reality it is the (unknown) sign that has changed, or else a conclusion of systematic drifting between two states may be reached, whereas all that is present is an effect of spread in the timepiece movement.

It would therefore seem desirable to establish a physical definition of the beat setting in the form of a signed geometric quantity. First of all, the beat setting may be rendered invariable with respect to the amplitude by applying a conversion that takes account of the amplitude noted at the time of measurement. Next, the sign of this quantity can be determined in a number of non-invasive ways and without the need to modify the position of the balance spring stud carrier (and therefore without unsetting the beat setting) as has hitherto been the case.

From a geometric standpoint, the beat setting corresponds to the angular offset (measured in terms of angle of rotation or of pivoting of the inertial element, notably of the balance) between:
the line of centers of the escapement, and
a line passing through the center of a salient element as for example an impulse pin or a finger cooperating with the pallet assembly and the axis of the inertial assembly, notably of the balance,
   in the position of the inertial assembly for which the return spring, notably the hairspring, applies zero torque. In other words, the reference can be expressed as an oriented angle of the position of the inertial element around its pivot axis. As mentioned hereinabove, the beat setting has historically been defined and measured in milliseconds.

This time corresponds to the above-mentioned angular offset and will be dependent on the speed of the inertial element at the neutral point, and therefore on the amplitude and frequency thereof. Ultimately, the lower the amplitude, the greater the difference in time over two alternations. The objective of switching to a geometric beat setting is to relate a temporal offset over a periodic function to an angular offset which is constant and indicative of the direct physical cause of the offset. Taking the amplitude at the time of measurement into account therefore has the effect of making the beat setting constant over the entire unwinding of the mainspring or despite any drift in amplitude over time.

A mathematical development using a small angles approximation enables the geometric beat setting to be expressed as an angle, using the following formula:

Rg=π×f×Rt×A

where:
Rg is the geometric beat setting [°],
f is the frequency of the oscillator [Hz],
A is the amplitude [°] of the timepiece movement of the inertial element, and
Rt is the temporal beat setting [s].

The beat setting can therefore be expressed as an angular quantity or as a temporal quantity.

Conversely, the variation in beat setting as a function of amplitude can be expressed using:

Rt(A)=(sin⁻¹(Rg/A))/(π×f)≈Rg/(A×π×f) if Rg/A is small.

It is thus clearly evident that the temporal beat setting is proportional to the inverse of the amplitude of the timepiece movement of the inertial element.

Another important aspect concerns the sign of the beat setting. On the basis of the equation (t1−t2)/2, it can be seen that the beat setting may be positive or negative depending on the values of t1 and t2. In practice, acoustic measurement equipment makes no distinction between entry alternations and exit alternations. As a result, this quantity is always communicated in terms of absolute value.

This convention poses problems not only in terms of the statistical analysis of the data (as the data obtained has a non-Gaussian distribution), but also in adjusting the beat setting and understanding the phenomena affecting the beat setting, such as drift as a result of shocks, phenomena induced by exposure to magnetic fields, or any other device that introduces spread. Knowing the sign or direction of the beat setting thus offers a real benefit.

For example, in terms of the timepiece movement, the following convention may be chosen: the beat setting is defined as positive when the line from the neutral point of the oscillator has a positive angular offset (counterclockwise or trigonometrical direction when viewed from the back side, namely the face-down direction) with respect to the line of centers passing through the pivot point of the pallet assembly staff and the pivot point of the oscillator staff. Otherwise, it will be negative.

Thus, in the example of FIG. 2, the action of moving a balance spring stud carrier in the counterclockwise direction as viewed from the back side (face-down direction) corresponds to making the beat setting more positive. This definition remains valid if the timepiece movement comprises some other way of adjusting the beat setting rather than the traditional balance spring stud carrier.

In general, and on the basis of the above formulae, the temporal and geometric beat settings will have the same sign, the time t1 corresponding to the alternation on the exit function and t2 to the alternation on the entry function. For t1>t2, the sign is positive. Of course, these sign conventions are dependent on the orientation of the line of centers, on the geometry of the escapement, or else on the design of the timepiece movement. However, it is easy by analogy to establish a convention for each caliber.

Hitherto, the direction or sign or orientation of the beat setting could be determined only by moving the balance spring stud carrier in a given direction and by measuring how the beat setting changes, thereby losing the initial setting of the beat setting. Specifically, the methods known hitherto did not provide knowledge of the sign of the beat setting without performing a number of successive adjustments and measurements.

Although never hitherto used, the sign of the beat setting is a vital piece of information in analyzing this quantity and adjusting the timepiece movement. As detailed later on, there are a number of possible techniques for determining the sign, notably a number of acoustic measurements, an optical-acoustic measurement, an analysis of a raw signal, a measurement in a non-Galilean frame of reference, etc.

The embodiment of the method for determining the beat setting that is set out later on makes use of the radial play in the inertial element pivot. Data in the possession of the applicant reveals that this play has an influence on the beat setting: the beat setting varies greatly according to the vertical orientation of the timepiece movement (for example according to the 3-o'clock, 6-o'clock, 9-o'clock and 12-o'clock positions). A numerical curve fitting process enables the sign and the value of the beat setting to be determined, using a model that is particularly simple to implement with known equipment, notably with acoustic measurement equipment.

### Method for Determining a Value for the Beat Setting

One embodiment of a method for determining a signed beat setting in a timepiece movement is detailed below. The method may use acoustic measurements taken in several positions, notably in the four vertical timepiece positions. On the basis of a theoretical model that uses the play in the inertial element pivot, and on the basis of conventions, it is possible to assign signs to the beat setting results initially measured in absolute terms. The principle consists in comparing and fitting a regression sinusoidal function best corresponding to the beat setting measurements obtained in different positions, for example best corresponding to four beat setting measurements obtained at different vertical positions.

In general, in order to determine, notably in order to calculate, a beat setting value for the oscillator 2 in the timepiece movement 200, the method comprises at least the following steps:
Setting the oscillator in oscillatory motion relative to the frame 99 of the timepiece movement,
Positioning the timepiece movement in at least two distinct and defined (or determined) positions with respect to the direction of the Earth's gravitational field,
For each position, determining, notably by measurement and processing, data relating to the beat setting of the oscillator 2, and in particular an absolute value of the beat setting of the oscillator 2,
Using the data from the previous step to determine the value of the beat setting of the oscillator 2, notably to calculate:
a directional value of the beat setting of the oscillator 2, and/or
a function defining the directional value of the beat setting of the oscillator 2 according to the position of the timepiece movement with respect to the direction of the Earth's gravitational field.

The positions are defined, which means to say that the spatial orientations of the timepiece movement are known.

The value of the beat setting is a directional value or a signed value, which is to say a value that can be positive or negative.

The value of the beat setting may be a temporal value, notably a temporal value expressed in milliseconds. Such a value is dependent on the frequency of the oscillator and on the amplitude of the oscillations of the inertial element.

As a preference, the value of the beat setting may be a geometric value, notably an angle value expressed for example in degrees. Such a value offers the advantage of being independent of the frequency of the oscillator and of the amplitude of the oscillations of the inertial element.

The method is implemented while the oscillator is in motion. Specifically, in the method, various actions are performed, notably measurements are taken, while the oscillator is in motion. Thus, the method comprises a step of setting the oscillator in motion. This may be performed by rewinding the mainspring so that it stores sufficient energy to ensure nominal operation of the timepiece movement.

The timepiece movement is successively positioned in at least two determined, namely distinct and defined, positions with respect to the direction of the Earth's gravitational field. For example, these positions may include reference timepiece positions in which the timepiece movement is vertical, particularly a 3-o'clock position, a 6-o'clock position, a 9-o'clock position, a 12-o'clock position or any vertical position intermediate between two of the aforementioned vertical positions.

The method may be implemented by positioning the timepiece movement in a number of distinct positions relative to the direction of the Earth's gravitational field.

The horizontal timepiece positions, notably the face-down and face-up positions, are not desirable positions for implementing the determination method.

For each position, data relating to the beat setting of the oscillator 2 is determined. For example, use is made of acoustic data making it possible to determine, notably by calculation, the beat setting data by using the formula |(t1−t2)/2| as seen earlier. In order to do this, for example, beat setting data is measured in each of the positions. For example, use is made of apparatus for measuring variations in the intensity of an acoustic phenomenon and an acoustic signal is obtained. By processing this signal it is possible to determine the values t1 and t2. These values are then used in processing or calculation to determine an absolute value for the beat setting.

The beat setting data obtained in the simplest way are temporal beat setting data (which are unsigned or non-directional).

However, the method advantageously comprises a step:
of determining an amplitude of oscillation of the oscillator 2, or
of measuring the amplitude of oscillation of the oscillator,
   at the moment at which the beat setting data is measured or determined. The method further advantageously comprises a step of using the amplitude of oscillation of the oscillator 2 to determine, by calculation, angular beat setting data, corresponding to the temporal beat setting data.

If the amplitude of oscillation of the oscillator does not vary or varies only little throughout all the measurements in the different positions, it is possible to determine, notably by measurement and calculation, the amplitude of the oscillator just once and to assume this amplitude to be constant throughout all the measurements taken in the different positions.

If the amplitude of oscillation of the oscillator varies throughout all the measurements in the different positions, it is preferable to determine the amplitude of the oscillator in each position and to associate these different amplitude measurements with the different positions and with the different beat setting data obtained in the different positions.

The determination or determinations, notably the measurement or measurements, of the amplitude may be performed in one and/or the other of the distinct and defined positions. Alternatively, the determination or determinations, notably the measurement or measurements, of the amplitude may be performed in all other positions.

Finally, the data relating to the beat setting (temporal beat setting data and, where appropriate, oscillator amplitude data) are used to determine, through calculation, the beat setting value of the oscillator 2, notably to calculate
a directional value of the beat setting of the oscillator 2, and/or
a function defining the directional value of the beat setting of the oscillator 2 according to the position of the timepiece movement with respect to the direction of the Earth's gravitational field.

In this step, preferably all the beat setting data obtained along with their opposite values are used to define 2n combinations of data (assuming that the timepiece movement has been positioned in n positions and that a beat setting data item has been obtained for each position). Each of these positions is associated with an angle λ (in accordance with standard NIHS 95-10). A search is then made for the combination best correlated with a sinusoidal function expressing the beat setting value as a function of the angle λ and this function is then retained as being the expression for the beat setting value of the timepiece movement tested as a function of the angle λ, which is to say as a function of the position of the timepiece movement relative to the direction of the Earth's gravitational field.

When the design of the timepiece movement is known, aberrant combinations can be determined as explained later. For example, a combination indicating a minimum beat setting data that has been determined in a position in which the beat setting data ought to be a maximum will not be retained.

In instances in which the position of the timepiece movement is neither a vertical position or a horizontal position, the angle of orientation of the timepiece movement λ is the directional angle formed between:
an orientation extending from the center of the dial and pointing toward the 12-o'clock mark, and
the orthogonal projection, onto the dial or onto a plane perpendicular to the axis of pivoting of the oscillator or onto a main plane P of the timepiece movement or onto the frame of the timepiece movement, of a vector parallel to the direction of the Earth's gravitational field and oriented upward.

This angle is positive in the direction from the orientation pointing toward the 12-o'clock mark toward the orientation pointing toward the 3-o'clock mark, namely when turning in the direction of the hands of a watch over the dial.

Advantageously, the concept of signed beat setting is combined with that of the geometric beat setting in order to obtain a new definition for the beat setting which directly links the determined value to the physical cause and offers numerous possibilities of use to improve the chronometric performance of the timepiece movement as well as to gain in efficiency during assembly and adjusting operations. In particular, as seen earlier, a signed geometric beat setting value is a directional angle value. This value is independent of the amplitude of the oscillations of the inertial element and of the frequency of the oscillator.

It can be seen that play in the timepiece movement, particularly a radial play in the inertial element pivot that alters the beat setting according to the orientation of the timepiece movement relative to the direction of the Earth's gravitational field. Specifically, the inertial element staff has shake (axial) and play (radial). In a vertical position, the inertial element pivots will bear against the pivot jewels, and this will have the effect of moving the center of rotation of the oscillator with respect to the frame. The orientation of the line of centers is thereby also modified, thus changing the value of the beat setting. For a given caliber, by way of example, an estimate of the variation in beat setting brought about by the difference in position of the pivot between a pivot that is centered and a pivot that is bearing against the pivot jewel amounts to 0.76°, which corresponds to a temporal beat setting of 0.25 ms with an amplitude of oscillation of 240° and an oscillator frequency of 4 Hz. Beat setting measurements taken at closely spaced intervals throughout a complete rotation in vertical positions about an axis perpendicular to the frame and/or to the dial of the timepiece movement will reveal a total variation in beat setting that is of the order of 0.5 ms. This “play” phenomenon therefore appears to explain the variations in beat setting that are observed in practice.

Because the beat setting is dependent on the position of the timepiece movement, it is possible to establish a model connecting these two variables. This model thus makes it possible to determine the sign of the beat setting measured in the different positions. However, it would seem necessary to establish conventions to ensure that the reasoning is always performed in the same frame of reference.

This refers to the orientation (λ in the standard NIHS 95-10) for denoting the angular position of the timepiece movement in a vertical position with respect to the center thereof. The 0° position corresponds to the timepiece 12-o'clock position. The direction is positive when the timepiece movement when viewed from the dial side (in the face-up direction) is turning in the counterclockwise direction: it is therefore moves from the 12-o'clock) (0° position to 3-o'clock) (90° position and so on. The inclination (θ in standard NIHS 95-10) corresponds to the angle defined between a vertical axis oriented in the opposite direction to that of the Earth's gravitational field (axis Z in standard NIHS 95-10) and the plane P of the timepiece movement. The position viewed from the dial side is defined as 90° and the position viewed from the back side as −90°.

It is also appropriate to define a sign convention. The beat setting will be said to be increasingly more positive when the line of the neutral point (passing through the pivot point of the axis of pivoting of the oscillator and through the center of the salient element, as the center of the pin, when the inertial element is in the position of rest) is moved in the counterclockwise direction when viewed from the face-down direction, with respect to the escapement line (or line of centers, which is the line situated in the plane P of the timepiece movement that passes through the axis of pivoting of the oscillator and through the axis of pivoting of the pallet assembly).

Knowing that the beat setting is dependent on the play in the pivot, it is also possible to define the orientations that correspond to the minimum and maximum beat setting data.

FIG. 3 shows a regulating system 100 from the face-up side in the 12-o'clock position (λ=0°, θ=90°). The extreme values of the beat setting must be observed when the line of centers L is in a horizontal position. Knowing that the line of centers L is inclined by 150° with respect to the 12-o'clock position, the extreme values and the middle value for the beat setting are given by the following orientations (with respect to 12-o'clock):
−300° or 60°. The beat setting has its minimum value at
−120° or 240°. The beat setting has its maximum value at
−30° or 150°. The beat setting has its middle value, which may be referred to as “midpoint beat setting”.

If a measurement (in terms of absolute value) indicates a high beat setting value (higher than the other measured values) associated with a position in which the beat setting ought to have a minimal value, it may be deduced therefrom that the beat setting is negative in this position and that a negative value must therefore be considered.

It is possible to establish a theoretical model that makes it possible to define the value of the beat setting as a function of the position of the timepiece movement relative to the direction of gravity. To a first approximation, the beat setting conforms to a function of the type:

R(λ)=R0×sin(λ−φ)+M

where:
R(λ) is the beat setting (which is signed or directional) as a function of the orientation of the timepiece movement; the beat setting may be expressed temporally, in [ms] or geometrically as an angle in [°]
R0 is the amplitude of the sinusoidal function, always positive,
λ is the orientation of the timepiece movement relative to the direction of the Earth's gravitational field (0-360°),
φ is the phase shift determined or defined by the design of the timepiece movement, particularly determined or defined by the direction of the line of centers,
M is the offset, positive, zero or negative (corresponds to the beat setting at the midpoint, which is to say when the orthogonal projection of the direction of the Earth's gravitational field onto the dial or onto the plane perpendicular to the axis of pivoting of the oscillator or onto the main plane P of the timepiece movement or onto the frame of the timepiece movement is parallel to the line of centers).

Since the parameter φ is predefined on the basis of the design of the timepiece movement, on the basis of beat setting data measured for different positions of the timepiece movement, only the parameters R0 and M still need to be calculated in order to define the value of the beat setting of a timepiece movement for all its positions relative to the direction of the Earth's gravitational field. One solution can be obtained using the method of least squares in order to determine, by calculation, a sinusoidal function best corresponding to the data relating to the beat setting of the oscillator which have been measured in different positions of the timepiece movement.

The parameter M corresponds to the theoretical beat setting that the oscillator would have if there were no play in the pivots. The term “midpoint” or “midpoint beat setting” in respect of this parameter M can be used because it makes it possible to describe the overall or mean behavior of the beat setting and is equal to the mean of the beat setting values obtained in four vertical positions spaced 90° apart, for example in the four vertical timepiece positions.

As was seen earlier, the beat setting data obtained by measurement are all positive. However, depending on the adjustment of the timepiece movement, the signed beat setting data may be all positive or all negative or, if the timepiece movement has been properly set to the beat setting, some of them may be positive and some negative.

For example, in a first phase, the beat setting data are measured (in absolute value) in the four vertical test positions. Table 1 below presents the results obtained.

TABLE 1

| | Orientation | Beat setting |
|---|---|---|
| Position | λ [°] | [ms] |
| 3-o'clock | 90 | 0.068 |
| 6-o'clock | 180 | 0.361 |
| 9-o'clock | 270 | 0.429 |
| 12-o'clock | 0 | 0.022 |

In a second phase, the sign of each measurement is determined. Specifically, on the basis of these four measurements, 2⁴=16 combinations of signed values would be possible. It is necessary to determine the combination of signed values that actually does correspond to the result of the test performed on the timepiece movement. Through knowledge of the design of the timepiece movement tested, it has been able to be established that the beat setting data for the 3-o'clock position is the value closest to the minimum and that the beat setting data for the 9-o'clock position is the one closest to the maximum. As a result, the combinations to be retained need to obey the following condition: Beat setting (3-o'clock)<Beat setting (9-o'clock). In most cases, this condition makes it possible to reduce the number of solutions. Moreover, the sign for each data item may be determined by matching the function R(λ) to the data by trying different combinations of sign. The most probable solution is the one that minimizes for example the sum of least-squares between the theoretical function R(λ) and the points defined by the different combinations of data mentioned above. Other optimization or regression methods may be used.

In a third phase, the final solution is expressed in the following form, the beat setting values being the measured values to which there has been added the sign of the values calculated according to the theoretical model established using the data obtained during the test performed on the timepiece movement:

TABLE 2

| | | Difference |
|---|---|---|
| | Beat | between mea- |
| | setting | surement and |
| Position | [ms] | model [ms] |
| 3-o'clock | −0.068 | −0.006 |
| 6-o'clock | 0.361 | −0.025 |
| 9-o'clock | 0.429 | 0.017 |
| 12-o'clock | 0.022 | 0.014 |

On the basis of the model established, it is also possible to determine, through calculation, the value of the beat setting at the midpoint (namely in the position of the timepiece movement at which the orthogonal projection of the direction of the Earth's gravitational field onto the dial—or onto the plane perpendicular to the axis of pivoting of the oscillator or onto the main plane of the timepiece movement or onto the frame of the timepiece movement—is parallel to the line of centers). This value for the beat setting at the midpoint is equal to +0.19 ms (or 0.57° for the beat setting expressed geometrically). Thus, as a preference, the function defining the directional angular value of the beat setting according to the position of the timepiece movement (orientation λ) can be determined as a sinusoidal function (of the orientation λ of the timepiece movement) best corresponding to the data relating to the beat setting of the oscillator. Thanks to such a sinusoidal function, it is possible to interpolate the value of the beat setting of the timepiece movement in any one of its positions (provided that the direction normal to the dial makes an angle of at least 2°, preferably of at least 3° with the direction of the Earth's gravitational field). It is thus possible to know a beat setting value for a position of the timepiece movement in which no beat setting measurement has been taken.

The foregoing example clearly illustrates the limitations of the traditional definition of the beat setting and of the corresponding measurement (temporal beat setting measured in absolute value): measurements in vertical positions yield two values close to zero (0.02 and 0.07 ms) and two values close to the maximum of the tolerance (0.36 and 0.43 ms). It was difficult for the watchmaker to adjust the beat setting: should he/she leave the timepiece movement as-is on the basis of one of the near-zero measurements obtained, or correct it on the basis of one of the other two measurements obtained? In addition, if the watchmaker were to opt to make a correction, which beat setting value should said watchmaker be aiming to achieve? Specifically, while the mean of the signed beat setting measurements in four vertical positions is equal to the beat setting at the midpoint, the same is not true of the mean of the four “standard” measurements of the beat setting which are measurements in terms of absolute value. It may be seen that the usual exhortation to “set the beat setting to zero in all positions” is simply not at all achievable in practice.

As indicated above, other approaches for determining the sign of the beat setting may be envisioned, in place of or to supplement the fitting of the measurements to sinusoidal function. A number of foundational ideas are outlined below.

### Distinguishing the Sign on the Basis of the Acoustic Signature

As a general rule, and particularly in the case of Swiss lever anchor escapements, it is difficult to distinguish between the acoustic signatures of two successive alternations. As a result, acoustic equipment does not take this criterion into consideration. However, in certain calibers and certain types of escapement, this difference is very marked and can be exploited to deduce the sign of the timepiece movement. Taking this concept further, a distinction between each signature specific to each caliber can be made using supervised classification algorithms (K Nearest Neighbors, Support Vector Machine or Neural Network).

### Distinguishing the Sign Using Optical-Acoustic Measurement

In the absence of beat setting measurement, optical measurement (dual channel) can be used to determine the direction of passage of the inertial element on each alternation. By combining this technology with an acoustic measurement it becomes possible to determine the direction of an alternation for each time measurement and from this deduce the sign of the beat setting.

### Distinguishing the Sign by Excitation of the Timepiece Movement

It is generally not possible to distinguish the “tick” from the “tock” in acoustic measurement. This problem can be circumvented by taking a first measurement in a stationary state (timepiece movement fixed) and then a second with an angular acceleration the direction of which is known. If the acceleration is applied with a center of rotation that coincides with that of the inertial element (non-Galilean frame of reference), the inertial element is subjected to a torque that generates an angular offset at the balance spring. The value of the beat setting will therefore be in error dependent on the angular movement applied to the balance spring. The sign of the beat setting can be deduced by observing whether the beat setting increases or decreases during measurement under acceleration: for example, if the beat setting increases while the plate is turning it will be known that this is a departure from the zero with respect to the measurement when stationary. It then becomes possible to determine the sign of the beat setting. The sign of a beat setting that is very close to zero could, however, be difficult to identify. One improvement would be to apply a gradual acceleration, initially very weak so as to be able to detect the change in the measurement and possibly a change in sign as the torque increases. An alternative method consists in exciting the timepiece movement with a short impulse at a very precise moment in time so that this disturbance is synchronized with an alternation of the timepiece movement, when the oscillator is close to the escapement function (in the middle of an alternation). Knowing that the orientation of the impulse is known but that the “tick” and “tock” alternations need to be identified, an arbitrary disturbance to one of these will generate either an increase or decrease in amplitude. The algorithm will thus be able to associate the alternations with the direction of rotation of the inertial element. The sign of the beat setting can therefore be identified.

As seen earlier, the use of the signed beat setting, particularly of the signed geometric beat setting, makes it possible to determine the midpoint, namely the actual difference between the neutral point of the oscillator and the line of centers. It is recalled that traditional measurement yields an absolute value. The applicant's results demonstrate that this beat setting value expressed temporally is dependent on the amplitude, that it therefore varies between horizontal and vertical positions, and that it typically varies by 0.5 ms between the extreme values measured in vertical positions because of the play in the pivot.

As was seen earlier, the method preferably comprises a phase of searching for the best fit of a sinusoidal function to the measurement points by trying out different combinations of signs for the measurement data obtained. Such a phase may be applied in a production work-flow.

The “overall” beat setting of each timepiece movement can thus be expressed through the midpoint beat setting (Table 3). This demonstrates the full benefit of using a signed value for the beat setting. Table 3 presents three scenarios:
The value of the beat setting is far from zero and positive. The standard means in terms of absolute value offer a good approximation for the midpoint beat setting, or even the correct value if it is the mean of the four vertical positions that is considered (timepiece movements 3, 5). This is unsurprising given the factors set out above.
The value of the beat setting is far from zero and negative (timepiece movements 2, 4). The same characteristics as above are seen again here, this time with an inversion of sign: the absolute value will be systematically incorrect. This has direct consequences on the adjusting of the beat setting: the watchmaker will for example be obliged to perform at least two cycles of adjusting and measuring to check.
The value of the beat setting is close to zero (timepiece movement 1). In this case, the mean of the values differs from the mean of the absolute values leading to a significant error (by a factor of 2 in the example) in the value of the beat setting, once again emphasizing the benefit of the approach developed in this document.

TABLE 3

| | | | Beat setting | Beat setting |
|---|---|---|---|---|
| | | Beat setting | in terms of | in terms of |
| | | in terms of | absolute | absolute |
| | | absolute | value, | value, |
| | Midpoint | value, | mean of | mean of |
| Timepiece | beat | mean of 6 | 2 horizontal | 4 vertical |
| movement | setting [°] | positions [°] | positions [°] | positions [°] |
| 1 | 0.16 | 0.27 | 0.18 | 0.31 |
| 2 | −0.51 | 0.52 | 0.54 | 0.51 |
| 3 | 0.63 | 0.66 | 0.73 | 0.63 |
| 4 | −0.93 | 0.90 | 0.84 | 0.93 |
| 5 | 1.27 | 1.40 | 1.66 | 1.27 |

In the embodiment described in detail above, the determination method is applied to the timepiece movement in vertical positions, namely with the inertial element staff in a position that is perpendicular to the direction of the Earth's gravitational field. The work conducted by the applicant demonstrates that it is necessary to avoid implementing the determination method with the timepiece movement in a horizontal position. However, as soon as an angle of around 2°, preferably 3°, or larger still can be measured between the oscillator staff and the direction of the Earth's gravitational field, the timepiece movement is in a position suitable for effective implementation of the determination method. This condition can be satisfied in one or some or all of the positions in which the timepiece movement is positioned in order to determine a beat setting data item.

In instances in which the timepiece movement is in neither a vertical position nor a horizontal position, the angle of orientation λ of the timepiece movement is defined as already indicated above, namely as being the directional angle formed between:
an oriented direction extending from the center of the dial of the timepiece movement and pointing toward a 12-o'clock mark, and
the orthogonal projection, onto the dial or onto the plane perpendicular to the axis of pivoting of the oscillator or onto the main plane of the timepiece movement or onto the frame of the timepiece movement, of a vector parallel to the direction of the Earth's gravitational field and oriented upward.

As a preference, at least one of the defined positions is such that the angle between:
the orthogonal projection of the line of centers L (line connecting the axis of oscillation of the oscillator and the axis of pivoting of the pallet assembly 31, perpendicular to these two axes) onto the dial of the timepiece or onto the plane perpendicular to the axis of pivoting of the oscillator or onto the main plane of the timepiece movement or onto the frame of the timepiece movement, and
the orthogonal projection of the direction of the Earth's gravitational field onto the dial of the timepiece or onto the plane perpendicular to the axis of pivoting of the oscillator or onto the main plane of the timepiece movement or onto the frame of the timepiece movement,
   is zero or has an absolute value less than 5° or has an absolute value less than 10°.

As a preference, at least two defined and distinct positions are vertical positions of the timepiece movement and/or positions approximately 90° apart about an axis perpendicular to the frame and/or to the dial (axis X according to standard NIHS 95-10) and/or at least 90° apart. More generally, at least two defined and distinct positions are positions of the timepiece movement that are such that the difference in angular orientation % of the timepiece movement between these two positions is 90° or approximately 90° or at least 90°.

Highly advantageously, at least a first defined position of the timepiece movement is such that the angle between:
the orthogonal projection of the line of centers L onto the dial of the timepiece or onto the plane perpendicular to the axis of pivoting of the oscillator or onto the main plane of the timepiece movement or onto the frame of the timepiece movement, and
the orthogonal projection of the direction of the Earth's gravitational field onto the dial of the timepiece or onto the plane perpendicular to the axis of pivoting of the oscillator or onto the main plane of the timepiece movement or onto the frame of the timepiece movement,
   is zero or has an absolute value less than 5° or has an absolute value less than 10°, and
   at least a second position of the timepiece movement is such that the difference in angular orientation λ of the timepiece movement between these first and second positions is ±90° or approximately ±90°, and, optionally,
   a possible third position of the timepiece movement is such that the difference in angular orientation λ of the timepiece movement between these first and third positions is ±90° or approximately ±90°,
   the second and third positions being distinct positions, namely positions such that the difference in angular orientation λ of the timepiece movement between these second and third positions is 180° or approximately 180°.

Advantageously, the second and third positions are therefore defined and distinct positions such that the angle between:
the orthogonal projection of the line of centers L onto the dial of the timepiece or onto the plane perpendicular to the axis of pivoting of the oscillator or onto the main plane of the timepiece movement or onto the frame of the timepiece movement, and
an orthogonal projection of the direction of the Earth's gravitational field onto the dial of the timepiece or onto the plane perpendicular to the axis of pivoting of the oscillator or onto the main plane of the timepiece movement or onto the frame of the timepiece movement,
   is equal to 90° or has an absolute value comprised between 85° and 90° or has an absolute value comprised between 80° and 100°. In such second and third positions it is possible to measure extreme beat setting values or values close to the extreme beat setting values.

In general, the higher the number of measurement points the more reliable and precise will be the determination of the beat setting value. For a timepiece movement of unknown design it is recommended for the timepiece movement to be positioned in at least three, preferably four, positions, notably in four vertical positions or positions that are inclined by at least 2° with respect to the horizontal. When the design of the timepiece movement is known, and therefore the positions of the minima, zeros and maxima of the theoretical sinusoidal function R(λ) are known, it is possible to position the timepiece movement in just two vertical positions (or positions inclined by at least 2° with respect to the horizontal) and to determine the value by elimination, notably by excluding certain combinations of sign that do not obey the sign convention and/or a physical reality (resultant amplitude R0 too high). Advantageously, the measurement positions may be spaced 90°, or more than 90°, apart or may correspond to positions for which the function R(λ) has a maximum or a minimum.

Whatever the embodiment or variant used to execute the method, the data relating to the beat setting of the oscillator 2 (absolute values of temporal beat settings) and/or amplitudes of oscillation of the oscillator 2 are determined for example by processing already-measured or already-acquired acoustic signals or by processing already-measured or already-acquired acoustic and optical signals.

### Methods for Adjusting the Beat Setting

The beat setting is systematically set or adjusted on each timepiece or watch movement either manually (for example by a watchmaker during an after-sales service or in a manual manufacturing work-flow) or automatically (for example on automatic production equipment). Hitherto, the absence of a sign on the beat setting has been not only problematical for adjusting the beat setting but has also limited industrial control over this quantity, notably by making statistical analysis difficult.

The usual approach to adjusting the beat setting has consisted in performing an iterative series of acoustic measurements. Between each measurement, the balance spring stud carrier is moved through a certain angle that is dependent on the value of the beat setting measured in the previous iteration, taking a gamble as to the direction of movement during the first cycle. By taking a measurement of the beat setting before and after correction and by knowing the direction in which the balance spring stud carrier has been moved, it is possible, in most cases, to deduce the direction in which to correct the beat setting. Another possibility is to move the balance spring stud carrier by a large amount in one direction so that there is no doubt as to the sign of the beat setting, and to then adjust the beat setting accordingly. However, this approach is laborious as it relies on several measurements of, and modifications to, the position of the balance spring stud carrier in order, iteratively, to arrive at the desired value.

By virtue of the solutions described above, the question of the direction of movement of the hairspring can be settled even before the first refinement iteration, thus limiting the operations to be performed on the balance spring stud carrier. Nor is it necessary for timepieces which, from the outset, have a beat setting that is within tolerance to have their setting lost in order to identify the sign of the beat setting. In order to do that, for example a series of measurements in vertical positions enables the sign of the beat setting to be identified as explained hereinabove. Expressed as a signed geometric beat setting, this measurement also enables the beat setting to be quantified through the midpoint which reflects the overall behavior of the timepiece movement.

One embodiment of a method for adjusting the regulating system 100 or the oscillator 2 is described hereinbelow. The adjustment method comprises:
a phase of implementing the beat setting-determining method that forms the subject of the invention, particularly a phase of implementing one embodiment of the determination method described hereinabove, and
a phase of adjusting the beat setting value of the oscillator 2.

The phase of adjusting the value of the beat setting advantageously involves moving a hairspring attachment support relative to the escapement and/or to the frame 99.

It would therefore appear to be effective:
to measure the beat setting in a number of vertical positions, for example four mutually orthogonal positions, and
to determine, through calculation, the beat setting at the midpoint by a fitting a function, for example a sinusoidal function or else any suitable function such as a polynomial function or Bezier function or spline function, to the measurement points.

This adjustment method allows the beat setting to be adjusted in a single operation, without carrying out iterative tests, while directly targeting the correct value. The correction is all the more effective if use is made of a determination of the signed geometric beat setting, which directly provides the correct angular value and the correct direction in which to make the correction. This procedure of measuring the beat setting and of setting the beat setting using the signed beat setting allows the distributions to be centered on a correct value, and spread to be controlled and reduced.

The adjustment method described above is robust inasmuch as it allows reliable and precise adjustment of absolutely any timepiece movement. However, this adjustment method can be improved (notably in terms of time and means of implementation) with knowledge of the design and/or the type of escapement in the timepiece movement that is to be adjusted.

Work conducted by the applicant has made it possible to predict how the value of the beat setting of a known timepiece movement will change as a function of the setup on which this timepiece movement rests. Knowing the orientation of the regulating system within the timepiece movement it is possible to determine a setup favorable for adjusting the beat setting. In particular, the setup adopted positions the timepiece movement at a known orientation λ. The result of this is that it is possible to determine the optimum value to which to adjust the beat setting in such a position, it being possible for this value to be a zero value, a maximum value, a minimum value, or else any other intermediate value.

In order to make such an adjustment, the timepiece movement is preferably positioned in such a way that the normal to the dial makes, with the direction of the Earth's gravitational field, an angle θ of at least 2°, preferably at least 3°. Any angle θ greater than 10°, particularly greater than 30° or greater than 45° appears to be particularly advantageous also from the viewpoint of ergonomic convenience to the watchmaker.

Thus, according to another way of executing a method for adjusting the regulating system 100 or the oscillator 2, use is made of:
a phase of positioning the timepiece movement in a predefined position, and
a phase of adjusting the value of the beat setting to a defined value, notably to a zero value or close to zero, in this predefined position.

In particular, according to the setup adopted, unlike that which is known from the prior art, it is also possible to proceed to adjust the beat setting by attempting to achieve a non-zero value for the adjustment. By benefiting from the influence that the orientation of the timepiece movement has on the measurement of the beat setting, it is also possible to specify the orientation of this movement during the adjustment so that a target of zero in this orientation yields a given value for the beat setting at the midpoint.

This adjustment can be performed for any type of escapement, including Swiss lever anchor escapements. However, it is of particular relevance to escapements with an asymmetrical operation where the beat setting has an influence on the running, such as Robin escapements.

Thus, according to another way of executing a method for adjusting the regulating system 100 or the oscillator 2, use is made of:
a phase of positioning the timepiece movement in a predefined position, and
a phase of adjusting the value of the beat setting to a non-zero value in this predefined position.

The phase of adjusting the value of the beat setting advantageously involves moving a hairspring attachment support relative to the frame 99.

Advantageously, the various ways of executing the adjustment method may be combined.

Thanks to the adjustment method according to the invention, the timepiece movement can be positioned in such a way that the angle between:
the orthogonal projection of the line of centers L onto the dial or onto the plane perpendicular to the axis of pivoting of the oscillator or onto the main plane of the timepiece movement or onto the frame of the timepiece movement, and
the orthogonal projection of the direction of the Earth's gravitational field onto the dial or onto the plane perpendicular to the axis of pivoting of the oscillator or onto the main plane of the timepiece movement or onto the frame of the timepiece movement,
   is zero or substantially zero, and
   therefore it is possible to implement a phase of adjusting the value of the beat setting in which attempts are made to get as close as possible to a zero value for the adjustment of the beat setting.

Alternatively, the timepiece movement can be positioned in another predefined position, the timepiece movement notably being positioned in such a way that the angle between:
the orthogonal projection of the line of centers L onto the dial or onto the plane perpendicular to the axis of pivoting of the oscillator or onto the main plane of the timepiece movement or onto the frame of the timepiece movement, and
the orthogonal projection of the direction of the Earth's gravitational field onto the dial or onto the plane perpendicular to the axis of pivoting of the oscillator or onto the main plane of the timepiece movement or onto the frame of the timepiece movement,
   is a right angle or substantially a right angle, and
   therefore it is possible to implement a phase of adjusting the value of the beat setting in which attempts are made to get as close as possible to a non-zero value for the adjustment of the beat setting.

By implementing the adjustment method described hereinabove, it is possible to obtain a correctly adjusted timepiece movement 200 or the correctly adjusted timepiece 300, notably a wristwatch.

The concept of “frame” used in this document can be replaced by the concept of “module” for example if the oscillator-escapement system is mounted and/or adjusted on a timepiece module intended to be assembled on a frame later.

Throughout this document, in order not to overcomplicate the wording, the term “beat setting” may be used to mean “beat setting value”.

Throughout this document, what is meant by “plane of the timepiece movement” or “main plane of the timepiece movement” is a plane perpendicular to the axes of the wheels of the geartrain. This plane is, for example, perpendicular to the axis of pivoting of the oscillator. This plane is preferably the plane in which the timepiece movement extends. For example, this plane is:
tangential to the largest surface of the frame, which surface is oriented perpendicular to the axes of the wheels of the geartrain, or
passes through that point of the frame at which the dial is positioned.

What is meant by “determining a value” is a collection of at least one step enabling a value to be established or enabling something or some phenomenon to be quantified. These steps include:
at least one measurement, and/or
at least one calculation, and/or
at least one mathematical or logic or computer processing operation.

What is meant by “determining a function” is a collection of at least one step enabling the function, notably the mathematical function, notably and more specifically the coefficients and/or constants of said function, to be established or defined. These steps include:
at least one measurement, and/or
at least one calculation, and/or
at least one mathematical or logic or computer processing operation.

### Adjustment Method for Facilitating Restarting

Throughout this document, the terms “restarting the balance”, “restarting the oscillator”, “restarting the escapement” and “restarting the timepiece movement” are used interchangeably.

Work conducted by the applicant has demonstrated that the restarting of the escapement can be facilitated by a particular adjustment of the timepiece movement, particularly a particular adjustment of the regulating system.

Assuming a timepiece movement with a Swiss lever anchor escapement comprising an escape wheel and a pallet assembly including an entry pallet and an exit pallet, it has actually become clear that there may be a difference in movement restart torque according to whether the escapement has stopped during an entry function or during an exit function (namely for example with a tooth of the escape wheel pressing against the impulse plane of the entry or exit pallet or else with the spur of the entry or exit pallet pressing against the impulse plane of a tooth of the escape wheel).

This restart torque is the torque to which the escape wheel is subjected (by the mainspring via the train) just before the timepiece movement restarts. This torque can be measured or determined at some other point, for example about the axis of pivoting of the pallet assembly or about the axis of rotation of a wheel of the train, particularly about the axis of rotation of the seconds wheel. Restarting is favored by limiting or reducing these torques.

It has also become apparent that it is possible to modify these restart torques, particularly to modify the aforementioned difference in restart torque, by modifying:
the beat setting (the definition, nature, determination and adjustment of which have already been mentioned), and/or
the degrees of penetration of the pallets into the teeth of the escape wheel.

In particular, work conducted by the applicant in search of solutions to the problem of restarting timepiece movements indicates that unusual, asymmetric or even counterintuitive adjustments of the beat setting and/or of the penetration of the pallets into the teeth of the escape wheel enable the situation to be improved.

The problems with restarting may vary considerably from one type of escapement to another. The studies have been directed more particularly toward dual impulse escapements where an impulse is transmitted on each alternation, such as Swiss lever anchor escapements for example. However, the results and solutions derived from these studies can be generalized to any type of escapement in which a blocker (particularly a pallet assembly) collaborates with an escape wheel.

The fact that there is an impulse on each alternation of the oscillator means that the salient element, as the impulse pin, secured to the oscillator enters a fork in the pallet assembly in two opposite directions. Ideally, from the restart standpoint, the energy transmission functions at the entry pallet and at the exit pallet need to be the same, otherwise restarting will be easier in one direction than in the other. The transmission of energy is dependent on the lever arm and on the friction, which may differ between the two functions because of the fact that the geometric configuration and orientation of the tooth-pallet force is not identical. The consequence of this is that, for restarting, it is necessary to have torques (applied to the pallet assembly and resulting from the lever arm and from the friction) that are equivalent on entry and on exit, in order to avoid having one side that is less favorable than the other.

However, in most cases, it is not desirable or not possible to have perfect balance on restarting. Optimizing an escapement is a multifunctional and multifactor problem where a trade-off has to be made between a number of performance factors and features such as efficiency, safety or even timekeeping. In other words, it is not desirable to design an escapement by imposing the same restart torque on the entry pallet as on the exit pallet, because this would have the effect of compromising the key performance of the escapement. In addition, the play in the various wheels and the positioning of the staffs in the pivots have a strong influence and vary from one timepiece movement to another (for the same reference of timepiece movement). During the search for solutions, it has therefore seemed relevant to adjust the timepiece movement to balance the restart a posteriori, namely once the movement has been produced.

In the case of a Swiss lever anchor escapement it is found that the nominal values for the degrees of penetration of the pallets into the teeth of the escape wheel are not the same on the entry and on the exit and that this difference leads to an approximately 20% difference in restart torque (typically 20% less torque is needed on exit than on entry for restarting the timepiece movement). For such an escapement, there is therefore an advantage to be had in drawing benefit from the developments and from targeting a different adjustment in order to optimize restarting with a minimal impact on running and amplitude. It would appear that this different adjustment may relate to:
the beat setting, and/or
the degrees of entry and exit penetration of the pallets into the teeth of the escape wheel (the entry interference between the circle centered on the axis of rotation of the escape wheel and passing through the crests of the teeth of the escape wheel and the circle centered on the axis of pivoting of the pallet assembly and passing through the top of the entry pallet; and, respectively, the exit interference between the circle centered on the axis of rotation of the escape wheel and passing through the crests of the teeth of the escape wheel and the circle centered on the axis of pivoting of the pallet assembly and passing through the top of the exit pallet).

In particular, it is possible to modify the single value of adjustment of the beat setting in order to balance the restart.

The adjustment method that forms the subject of the invention is applied to the regulating system 100 or to the timepiece movement 200 or to the timepiece 300 in order to balance and/or encourage the restarting thereof. It chiefly comprises:
a step of adjusting the beat setting, notably to a non-zero value, and/or
a step of adjusting the degree of entry penetration of the pallet assembly 31 into the escape wheel 32, and/or
a step of adjusting the degree of exit penetration of the pallet assembly 31 into the escape wheel 32.

The adjustment method is for example implemented at the end of manufacturing a timepiece movement or at the end of manufacturing a watch equipped with a timepiece movement or during an adjustment operation or during a chronometric certification operation or during an after-sales service operation.

More specifically, one way of performing an adjustment method according to the invention is described in detail hereinafter.

Prior to the adjustment step, the adjustment method comprises a step of defining the adjustment to be made. In other words, in this step, the nature and intensity of the adjustment that is to be made is defined.

The step of defining the adjustment may comprise:
a sub-step of measuring or determining or estimating the entry restart torque and of measuring the exit restart torque or a sub-step of measuring or determining or estimating the difference in restart torque between the entry and the exit; and
a sub-step of using the torque measurements or determinations or estimates or the measured or determined or estimated differences in restart torque to determine the nature and the intensity of the adjustment to be applied to the regulating system 100.

In the sub-step of measuring the entry restart torque and of measuring the exit restart torque it is possible for example to proceed as follows.
An operator positions the timepiece movement in a configuration that is defined by the following states:
   the timepiece movement is stopped,
   the mainspring is uncoiled,
   the pallet assembly is positioned in a middle position, for example centered between its two extreme positions,
   one tooth of the escape wheel is pressed against the impulse plane of the entry pallet.
The operator progressively rewinds the mainspring until the timepiece movement restarts.
The operator notes the number of turns of the winding crown or ratchet that have been needed in order for the timepiece movement to restart.
The operator then positions the timepiece movement in a configuration that is defined by the following states:
   the timepiece movement is stopped,
   the mainspring is uncoiled,
   the pallet assembly is positioned in a middle position,
   one tooth of the escape wheel is pressed against the impulse plane of the exit pallet.
The operator progressively rewinds the mainspring until the timepiece movement restarts.
The operator notes the number of turns of the winding crown or ratchet that have been needed in order for the timepiece movement to restart.

The number of turns of the winder or ratchet that are needed to restart the timepiece movement while the escape wheel is in contact with the entry pallet and while the escape wheel is in contact with the exit pallet is therefore known. These numbers of turns of the winder are indicative of the restart torques. Specifically, in the configurations described, the torque supplied by the mainspring is an increasing (monotonic) function of the number of turns of the winder. It then follows that by knowing the number of turns of the winder that are needed for restarting, the restart torques are known. The values of these torques may be determined or evaluated. The difference in restart torque between the entry and the exit may thus be known.

In the sub-step of using the torque measurements to calculate a value for the adjustment to be applied to the regulating system 100, the previously defined torque values or their differences are used to determine the nature (adjustment to the beat setting and/or adjustment to the penetration) and the intensity of the adjustment to be applied to the regulating system 100.

As regards the nature of the adjustment, the operator may make an adjustment to the beat setting and/or an adjustment to the penetration. The choice of the one and/or the other of the natures of adjustment can be guided by:
the magnitude of the restart torque correction to be made, and/or
other constraints such as, for example, limiting values of beat setting and/or of penetration that must not be exceeded, and/or
one nature of adjustment to be favored over another for example according to the nature or structure of the escapement.

In order to determine the adjustment to be made, use is made for example of the following formula:

Mred=M0+ap×p+ar×r

where
Mred is the difference in restart torque between the entry restart torque and the exit restart torque,
p is the difference in penetration between the entry penetration and the exit penetration,
r is the beat setting (signed),
M0, ap and ar are constants.

Specifically, an analysis of measurements made on five movements (equipped with a broken-line Swiss lever anchor escapement with fine pallets) has made it possible to establish a connection in the aforementioned form between the restart torque, penetrations, and beat setting.

The restart measurements were made on entry and on exit for different beat setting values. The entry and exit restart torques are given in FIG. 4 as a function of the beat setting. The entry measurements are connected by dashed lines and the exit measurements by solid lines. The entry and exit penetrations are, respectively, 66 μm and 75 μm (mvt 1), 68 μm and 68 μm (mvt 2), 73 μm and 74 μm (mvt 3), 72 μm and 68 μm (mvt 4), and 70 μm and 74 μm (mvt 5). It may be noted that the restart performances are, to a first approximation, linear in the beat setting range considered (typically between −3° and +3°, or even between −8° and +8°) and that the entry and exit are the opposite of one another, having a gradient that may vary between the two functions according to the design of the escapement. The point of intersection of the straight lines (representing the entry restart torques and the exit restart torques) corresponds to a point where entry and exit performance is balanced. For this sample of five movements, balance is achieved for a midpoint beat setting value of between −1.1° and +1.2°, depending on the timepiece. The torque values at this balance point lie between 24 and 28 μNm (torque measured at the seconds wheel).

From an adjustment sensitivity standpoint, on this type of movement and of escapement, it is found that the torque varies according to the manual winding and possibilities of adjustment, in accordance with the following characteristics:
Winding stem turns: 3 to 4 [winding stem turns/μNm] (corresponding to approximately one revolution of the mainspring for this caliber);
Penetrations: 1 to 2 [μm/μNm] or 0.5 to 1 [μNm/μm];
Beat setting: 0.5 to 2 [°/μNm] or 0.5 to 2 [μNm/°].

Advantageously, the position of this point of intersection is also dependent on the values of the penetrations: FIG. 5 thus shows the difference in restart torque as a function of the difference in penetration. It may be seen that the balance point (where the difference in torque is 0 Nm) is indeed dependent on the difference between the entry and exit penetrations. In this particular instance, if a symmetrical adjustment of the penetrations is taken as a reference point, the optimal beat setting (with respect to restart torques) is at +1°. If a penetration of +4 μm on the exit side compared with the entry side is accepted (as may be the case on certain calibers), the balance point for the restart torques is obtained with a beat setting at 0°. It is therefore advantageous to combine the two effects in order to make the restart symmetrical and balance the restart torques.

This combination of the two effects was analyzed by estimating the restart performance. The formula detailed above:

Mred=M0+ap×p+ar×r

was extracted from measurements taken over a population of movements, varying the beat setting and the penetrations.

As an example of this principle, in the case of FIGS. 4 and 5, the difference in restart torque Mred obeys the formula:

Mred=2.5+0.6×p−2.2×r

It is also possible to determine the distributions of the beat setting and penetration values on a sample of movements, for example across a production run. That makes it possible to estimate the distribution of the restart torques and then, with knowledge of the behavior of the train, convert the torque into turns of the winding stem. This then gives a projection of the restart performance of a population of timepiece movements.

In light of the analyses performed, it may be of key importance, when adjusting a beat setting, to determine the adjustment using a signed value. The methods for determining the signed beat setting which were described in detail earlier on in this document are therefore of great importance.

In instances in which the adjustment step comprises adjustment of the beat setting, in practice, the operator moves the distal end of the oscillator spring relative to the frame 99 by rotating it relative to said frame about the axis of the oscillator by an angular value corresponding to the correction or modification that is to be made to the beat setting. As a preference, the non-zero value to which the midpoint beat setting is adjusted is comprised between −3° and +3°, more specifically between −3° and −0.1° and between +0.1° and +3°, and the change to the beat setting is comprised between-3° and +3°, more specifically between −3° and −0.1° and between +0.1° and +3°.

In instances in which the adjustment step comprises adjustment of the entry penetration of the pallet assembly 31 into the escape wheel 32, the operator moves the entry pallet relative to the rest of the pallet assembly, this entry pallet being for example clamped in the rest of the pallet assembly and fixed to the rest of the pallet assembly using a hot-melt resin. Thus, heating the pallet assembly allows the entry pallet to be detached and therefore moved relative to the rest of the pallet assembly. As a preference, this movement is controlled using a micrometer or using a calibrated image capture measurement system. The entry pallet can be moved in a direction in which it protrudes from the rest of the pallet assembly or in a direction in which it is set further into the rest of the pallet assembly. Once the entry pallet has been moved into its target position, the pallet assembly cools and the hot-melt resin hardens again and fixes the entry pallet in its new position relative to the rest of the pallet assembly. The amount by which the entry pallet is moved is preferably less than 20 μm.

In instances in which the adjustment step comprises adjustment of the exit penetration of the pallet assembly 31 into the escape wheel 32, the operator moves the exit pallet relative to the rest of the pallet assembly, this exit pallet being for example clamped in the rest of the pallet assembly and fixed to the rest of the pallet assembly using a hot-melt resin. Thus, heating the pallet assembly allows the exit pallet to be detached and therefore moved relative to the rest of the pallet assembly. As a preference, this movement is controlled using a micrometer or using a calibrated image capture measurement system. The exit pallet can be moved in a direction in which it protrudes from the rest of the pallet assembly or in a direction in which it is set further into the rest of the pallet assembly. Once the exit pallet has been moved into its target position, the pallet assembly cools and the hot-melt resin hardens again and fixes the exit pallet in its new position relative to the rest of the pallet assembly. The amount by which the exit pallet is moved is preferably less than 20 μm.

Thus, for the one and/or the other of the pallets, the step of adjusting the penetration of the pallet assembly into the escape wheel may comprise:
a sub-step of measuring the entry penetration and/or the exit penetration, then
a sub-step of controlled movement of the corresponding pallet relative to the rest of the pallet assembly (that may include detaching the pallet from the rest of the pallet assembly), notably a sub-step of controlled movement of the corresponding pallet relative to the rest of the pallet assembly, then
a sub-step of securing the corresponding pallet to the rest of the pallet assembly.

As was seen earlier, depending on the modification to be made in order to promote and/or balance the restarting, actions are performed on any combination of one or more of the following characteristics:
the beat setting,
the position of the entry pallet,
the position of the exit pallet.

As was seen earlier, where there is a desire to modify the beat setting, it may be advantageous during the step of adjusting the beat setting to position the regulating system 100 at a given orientation relative to the Earth's gravitational field, in particular a given orientation in which:
the orthogonal projection of the direction of the Earth's gravitational field onto a plane perpendicular to the pivot axis of the inertial element is parallel or substantially parallel to the line of centers (L) (that is to say, in particular, that the two directions form an angle of less than 10° or less than 5°), and
the pivot axis of the inertial element forms an angle of at least 2° or at least 3° with the direction of the gravity field.

While the regulating system 100 is in position in the given orientation relative to the Earth's gravitational field, it is possible for example to set the beat setting to a zero value. This is practical because it is possible to dispense with the need to know the sign of the beat setting. However, because of the play due to operating clearances in the regulating system, the beat setting has a different and determined value when the regulating system, after adjustment, is positioned at another orientation. This approach to adjusting the beat setting is possible so long as the desired beat setting adjustment remains comprised between approximately ±1°. Typically, the aim is for a zero beat setting value in a movement orientation that is such that the mean beat setting or the midpoint beat setting (line of centers aligned with the direction of the gravitational field) adopts the target non-zero value.

The modification can also be made to the beat setting without precise knowledge of the value of the beat setting prior to correction. Specifically, the above-mentioned formula indicates the torque difference modification that is obtained for a given amount of modification to the beat setting (independently of the original setting that the beat setting had).

From the standpoint of the industrial-scale production of timepiece movements, it is possible to determine a nominal target restart torque for a batch, a series, or a production run on the basis of a few forerunner timepiece movements.

Alternatively, it is also possible to perform optimization on an individual basis, although this involves stopping the movement, measuring the restart torque required on entry and on exit, respectively, and then modifying the penetrations and/or the beat setting in order to balance the restart torques.

In summary, the method for obtaining balanced restarting is as follows, in instances in which an unbalanced restart torque is measured or observed:
The entry penetration is decreased or increased in order to modify the restart torque (depending on the sign of the dependency between the variation in entry penetration and the variation between entry and exit torque); and/or
The exit penetration is increased or decreased in order to modify the restart torque (depending on the sign of the dependency between the variation in exit penetration and the variation between entry and exit torque); and/or
The entry penetration is decreased and the exit penetration increased, or vice versa (depending on the sign of the dependency between the variation in penetrations and the variation in restart torque), particularly if there is a desire to maintain the same virtual engagements; and/or
The beat setting is modified toward entry or exit depending on the sign of the dependency between the variation in beat setting and the variation in the differential between entry and exit torque. By convention (and independently of the conventions mentioned earlier on in this document), the beat setting is oriented in such a way that if the beat setting increases, the restart torque on the exit pallet also increases.

The fact of operating both on the beat setting and on the penetrations opens the possibility of optimizing both the restarting and the operating safety, together.

With the solutions described, it is conceivable, for each timepiece considered individually, to adjust the beat setting independently according to the previously-measured penetration values.

This concept may be applied in particular to any type of dual impulse escapement. It is all the more important in structures in which penetration adjustment is no longer possible, such as in the case of a one-piece pallet assembly for example, which removes one of the ways in which to act in order to balance the restarting between entry and exit. Adjusting the beat setting to a non-zero value is then an excellent alternative, or even the only and/or simplest alternative to implement. The concept can be applied to any type of escapement with direct or indirect impulses, as well as to any type of escapement with tangential impulses.

The concept can in particular be applied to any type of oscillator, in particular an oscillator formed by an oscillating system with periodic oscillations. This oscillator can be formed of an inertial element and a return spring, as an oscillator formed of a balance and a hairspring, or as a flexible blade oscillator formed of an inertial element and at least two distinct flexible blades which return the inertial element to a rest position and allow the pivoting of the inertial element around a pivot axis.

It is important to note that the adjustments mentioned in the solutions described hereinabove have no impact on the running, or practically no impact on the running.

The invention also relates to the regulating system 100 or to the timepiece movement 200 or to the timepiece 300 which are obtained by implementing the adjustment method that forms the subject of the invention.

1. A method for adjusting a regulating system (100) comprising:
an oscillator (2) comprising an inertial element (21) pivoted around a pivot axis and a return spring (22), notably a balance-wheel (21)/mainspring (22) oscillator, and
an escapement,
the method comprising, in order to facilitate and/or balance the restarting of the regulating system:
adjusting a beat setting, and/or
adjusting a degree of entry penetration of a pallet assembly into an escape wheel, and/or
adjusting a degree of exit penetration of the pallet assembly into the escape wheel.

2. The method as claimed in claim 1, wherein the adjusting of the beat setting comprises positioning the regulating system at a given orientation relative to a gravitational field of Earth.

3. The method as claimed in claim 1, wherein the adjusting of the beat setting comprises adjusting the beat setting to a value, while the regulating system is positioned at the given orientation relative to the Earth's gravitational field.

4. The method as claimed in claim 1, wherein the beat setting is adjusted to a non-zero value comprised in a range of from −3° to +3°, and a change to the beat setting is comprised in a range of from −3° to +3°, the reference being defined as a signed geometric quantity and/or as corresponding to an angular offset, measured in rotation angle of the inertial element, between:
the line of centers of the escapement, and
a line passing through the center of a salient element and the axis of the inertial element, in the position of the inertial element for which the return spring applies a zero torque.

5. The method as claimed in of the claim 1, wherein the adjusting of the entry penetration of the pallet assembly into the escape wheel comprises:
measuring the entry penetration, then
performing a controlled movement of an entry pallet relative to the rest of the pallet assembly, then
securing the entry pallet to a rest of the pallet assembly.

6. The method as claimed in claim 1, wherein the adjusting of the exit penetration of the pallet assembly into the escape wheel comprises:
measuring the exit penetration, then
performing a controlled movement of an exit pallet relative to the rest of the pallet assembly, then
securing the exit pallet to a rest of the pallet assembly.

7. The method as claimed in claim 1, wherein the method comprises, prior to the adjusting, defining the adjustment to be performed, the defining of the adjustment comprising:
measuring or determining or estimating an entry restart torque and measuring or determining or estimating an exit restart torque, or measuring or determining or estimating a difference in restart torque between the entry and the exit, and
using torque measurements or determinations or estimates obtained in the measuring or determining or estimating to determine a nature and an intensity of the adjustment to be applied to the regulating system.

8. The method as claimed in claim 7, wherein the using of the torque measurements or determinations or estimates involves exploitation of the following formula:
Mred=M0+ap×p+ar×r
where
Mred is the difference in restart torque between the entry restart torque and the exit restart torque,
p is the difference in penetration between the entry penetration and the exit penetration,
r is the beat setting,
M0, ap and ar are constants.

9. A regulating system obtained by implementing the method as claimed in claim 1.

10. A timepiece movement comprising an adjustment system as claimed in claim 9.

11. A timepiece comprising a timepiece movement as claimed in claim 10.

12. The method as claimed in claim 1, wherein the inertial element is a balance wheel/mainspring oscillator.

13. The method as claimed in claim 12, wherein the escapement is a dual impulse escapement.

14. The method as claimed in claim 13, wherein the escapement is a Swiss lever anchor escapement.

15. The method as claimed in claim 1, wherein the adjusting of the beat setting includes adjusting the beat setting to a non-zero value.

16. The method as claimed in claim 2, wherein, in the adjusting of the beat setting,
the regulating system is positioned at a given orientation so that the reference set in the orientation coincides with the reference at the midpoint, and/or
a normal to a dial forms, with the direction of terrestrial gravity, an angle of at least 2°, and/or
the reference at the midpoint takes a targeted non-zero value.

17. The method as claimed in claim 16, wherein, in the adjusting of the beat setting, a normal to a dial forms, with the direction of terrestrial gravity, an angle of at least 3°.

18. The method as claimed in claim 3, wherein, in the adjusting of the beat setting, the beat setting is adjusted to a zero value.

19. The method as claimed in claim 4, wherein the non-zero value to which the beat setting is set is comprised in a range of from −3° to −0.1° and between +0.1° and +3°, and the change to the beat setting is comprised in a range of from −3° to −0.1° and between +0.1° and +3°.

20. The method as claimed in claim 5, wherein, in the adjusting of the entry penetration of the pallet assembly into the escape wheel, the controlled movement of an entry pallet relative to the rest of the pallet assembly is by less than 20 μm relative to the rest of the pallet assembly.
